(19) United States
(12) Patent Application Publication
(10) Pub. No.: US 2019/0384251 A1
(43) Pub. Date: Dec. 19, 2019

(54) PROGRAMMABLE LOGIC CONTROLLER, METHOD OF CALCULATING LIFE OF UNIT, AND LIMITED-LIFE-COMPONENT-EQUIPPED UNIT

(71) Applicant: Mitsubishi Electric Corporation, Chiyoda-ku (JP)

(72) Inventors: Yoshinobu SHIMIZU, Tokyo (JP); Masatoshi TOYONAGA, Tokyo (JP)

(73) Assignee: Mitsubishi Electric Corporation, Chiyoda-ku (JP)

(21) Appl. No.: 16/092,354

(22) PCT Filed: Jul. 18, 2017
(86) PCT No.: PCT/JP2017/025933

§ 371 Date: Oct. 9, 2018

(51) Int. Cl. G05B 19/05

(52) U.S. Cl. CPC G05B 19/05

(57) ABSTRACT

A programmable logic controller configured to include a control unit and a power supply unit equipped with a limited-life component. The power supply unit includes a remaining life storage unit to store remaining life information indicating the remaining life of the power supply unit. The control unit includes a load current calculation unit to calculate the load current flowing in the programmable logic controller; an estimated temperature calculation unit to calculate, on the basis of the ambient temperature information obtained from the user and the load current, an estimated value of temperature of the limited-life component when the programmable logic controller is in operation; and a remaining life calculation unit to update the remaining life information on the basis of the operating time of the programmable logic controller and the estimated value.

### FIELD

The present invention relates to a programmable logic controller having a function for assessing the life of a component; a control unit; and a method of calculating the life of a unit.

### BACKGROUND

A programmable logic controller (PLC, hereinafter referred to as a PLC) is generally composed of a plurality of units. A power supply unit, which is one of the units constituting the PLC, is equipped with limited-life components such as electrolytic capacitors, and the power supply unit itself has a given service life. In order to maintain the system of the PLC, it is necessary to manage when to replace units equipped with limited-life components, such as the power supply unit. Without doing this, there arises a problem in that the system suddenly stops when a limited-life component in a unit reaches the end of its life.

To counter such a problem, Patent Literature 1 describes an invention that calculates when to replace a power supply unit equipped with limited-life components while taking into account the property that the limited-life components have whereby the higher the temperature, the shorter their lives. The invention described in Patent Literature 1 measures the ambient temperature of the limited-life components and the operating time in a state where the ambient temperature has become equal to or higher than a predetermined value, and, on the basis of the measurement results, calculates when to replace the power supply unit or the remaining usable life of the power supply unit.

### CITATION LIST

### Patent Literature

Patent Literature 1: Japanese Patent Application Laid-open No. H11-175112

### SUMMARY

### Technical Problem

However, with the invention described in Patent Literature 1, there is a problem in that it is necessary to add a component for detecting temperature, resulting in an increase in cost.

The present invention has been made in view of the above, and an object thereof is to obtain a programmable logic controller capable of calculating when to replace a unit equipped with a limited-life component while at the same time preventing an increase in cost.

### Solution to Problem

In order to solve the above-mentioned problem and achieve the object, an aspect of the present invention is a programmable logic controller configured to include a control unit and a limited-life-component-equipped unit equipped with a limited-life component. The limited-life-component-equipped unit comprises a remaining life storage unit to store remaining life information indicating a remaining life of the limited-life-component-equipped unit. The control unit comprises a load current calculation unit to calculate a load current flowing in the programmable logic controller. The control unit further comprises an estimated temperature calculation unit to calculate, on the basis of ambient temperature information obtained from a user and the load current, an estimated value of temperature of the limited-life component when the programmable logic controller is in operation, and a remaining life calculation unit to update the remaining life information on the basis of operating time of the programmable logic controller and the estimated value.

### Advantageous Effects of Invention

The present invention has an effect such that a programmable logic controller can be provided that is capable of calculating when to replace a unit equipped with a limited-life component while at the same time preventing an increase in cost.

### BRIEF DESCRIPTION OF DRAWINGS

FIG. 1 is a diagram illustrating an example configuration of a programmable logic controller.

FIG. 2 is a flowchart illustrating an example operation of the programmable logic controller.

FIG. 3 is a diagram illustrating an example of first correspondence information.

FIG. 4 is a diagram illustrating an example of second correspondence information.

FIG. 5 is a diagram illustrating an example of rated current information.

FIG. 6 is a diagram illustrating an example configuration of hardware for realizing a control unit.

### DESCRIPTION OF EMBODIMENTS

Hereinafter, a programmable logic controller, a control unit, and a method of calculating the life of a unit according to embodiments of the present invention will be described in detail with reference to the drawings. Note that the invention is not limited to the embodiments.

### Embodiment

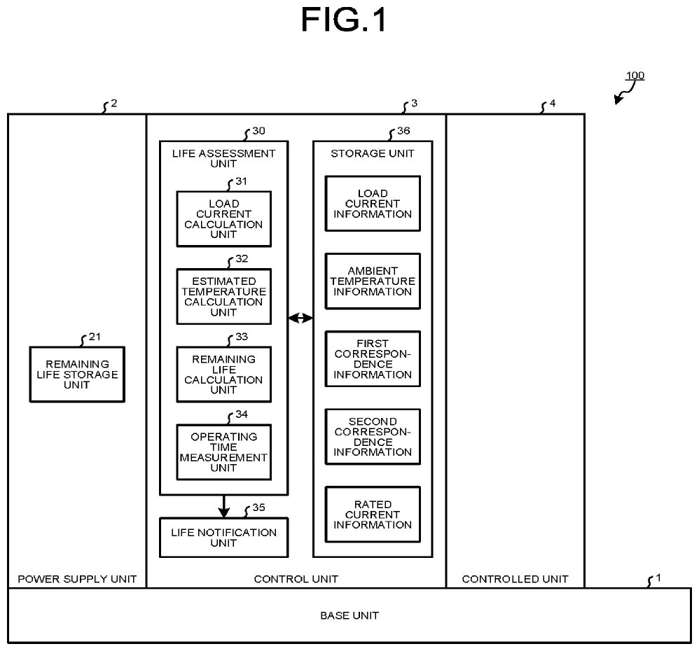

FIG. 1 is a diagram illustrating an example configuration of a programmable logic controller (PLC) according to an embodiment of the present invention. A PLC 100 according to the present embodiment is realized by combining a plurality of units. Specifically, the PLC 100 is configured from various units such as a base unit 1, a power supply unit 2, a control unit 3, and a controlled unit 4. Note that the PLC 100 includes one or more controlled units 4.

The base unit 1 electrically connects the power supply unit 2, the control unit 3, and the controlled unit 4. The power supply unit 2 supplies power to the control unit 3 and the controlled unit 4 via the base unit 1. The control unit 3 controls the controlled unit 4. The controlled unit 4 can be any kind of unit that performs operations according to instructions from the control unit 3. Examples of the controlled unit 4 include an input unit for receiving signals from a sensor or the like attached to production equipment and facility equipment, an output unit for outputting control signals to an actuator and the like, and a network unit for connecting the PLC 100 to a communication network.

The power supply unit 2 is equipped with a limited-life component that is not illustrated. The power supply unit 2 itself has a given service life. An example of a limited-life component is an electrolytic capacitor. When the power supply unit 2 is equipped with a plurality of limited-life components, the life of the power supply unit 2 is equal to the life of a limited-life component having the shortest life among the limited-life components in the power supply unit 2. The power supply unit 2, which is a limited-life-component-equipped unit, includes a remaining life storage unit 21 for storing remaining life information that is information on the remaining life of the power supply unit 2. The remaining life storage unit 21 is realized as a nonvolatile memory. The remaining life information stored in the remaining life storage unit 21 is updated by the control unit 3. The initial value of the remaining life information indicates the life of the power supply unit 2, i.e., the remaining life of the power supply unit 2 before the start of use. In the following description, the expression “remaining life” is used.

The control unit 3 includes a load current calculation unit 31, an estimated temperature calculation unit 32, a remaining life calculation unit 33, an operating time measurement unit. 34, a life notification unit 35, and a storage unit 36. The load current calculation unit 31, the estimated temperature calculation unit 32, the remaining life calculation unit 33, and the operating time measurement unit 34 constitute a life assessment unit 30 that calculates the remaining life of the power supply unit 2.

The load current calculation unit 31 calculates a load current flowing in the PLC 100. On the basis of the load current flowing in the PLC 100, the estimated temperature calculation unit 32 calculates the estimated temperature of the limited-life component when the PLC 100 is in operation. The remaining life calculation unit 33 calculates the remaining life of the power supply unit 2 on the basis of the estimated temperature of the limited-life component when the PLC 100 is in operation and the operating time of the PLC 100. The operating time measurement unit 34 measures the operating time of the PLC 100.

When the remaining life of the power supply unit 2 reaches a predetermined length, the life notification unit 35 notifies the user of this.

The storage unit stores information used by the units of the life assessment unit 30 when calculating the remaining life of the power supply unit 2, i.e., load current information, ambient temperature information, first correspondence information, second correspondence information, and rated current information. The storage unit 36 obtains these pieces of information in advance from the user via an input device that is not illustrated. Examples of the input device include a mouse, a keyboard, and a touch panel.

The load current information is information on the load current flowing in the PLC 100 when the PLC 100 is in operation. The load current flowing in the PLC 100 may be obtained by actually operating the PLC 100 and measuring the load current, or it may be obtained by calculating the total value of the rated currents of the units constituting the PLC 100 as the load current. The ambient temperature information is information on the ambient temperature of the PLC 100 before the PLC 100 operates. Before the PLC 100 operates, no currents flow in the components constituting the PLC 100 and thus no heat is generated. Thus, the ambient temperature of the PLC 100 can be regarded as the temperature of the limited-life component. That is, the information on the ambient temperature of the PLC 100 is also information indicating the temperature of the limited-life component before the PLC 100 operates. Even when the PLC 100 is not in operation, a standby current is still flowing therein. For this some other reasons, the ambient temperature of the PLC 100 may be different from the temperature of the limited-life component. However, the difference between the ambient temperature of the PLC 100 and the temperature of the limited-life component is usually constant. Thus, when the ambient temperature of the PLC 100 and the temperature of the limited-life component before the PLC 100 operates are different, information on the difference between these temperatures is also stored in the storage unit 36. At a production site where the PLC 100 is installed, temperature control is generally performed such that the temperature is constant. In such a case, a target temperature for the temperature control can be set to the ambient temperature of the PLC 100 before the PLC 100 operates. The first correspondence information is information indicating the correspondence relationship between the load current flowing in the PLC 100 and the amount the estimated temperature of the limited-life component rises. The second correspondence information is information indicating the correspondence relationship between the estimated temperature of the limited-life component in the PLC 100 and the life factor of the power supply unit 2. The life factor of the power supply unit 2 is a factor used by the remaining life calculation unit 33 in processing to calculate the remaining life of the power supply unit 2. The life factor of the power supply unit 2 can be expressed by the following formula (1), using, for example, the life of the limited-life component in the power supply unit 2 at each temperature and a life specification that is the life of the power supply unit 2 when the power supply unit is used in an environment at a specified ambient temperature (e.g. 20° C.). The rated current information is information on the rated currents of the units constituting the PLC 100.

(Life factor)=(life of limited-life component at each temperature)/(life specification) (1)

It should be noted that part or all of the information stored in the storage unit 36 of the control unit 3 may be stored in the power supply unit 2 or the controlled unit 4.

It is possible to eliminate the remaining life storage unit 21 from the power supply unit 2 and store the remaining life information on the power supply unit 2 in the storage unit 36 of the control unit 3. However, it is desirable that the power supply unit 2 includes the remaining life storage unit 21. This is because with a configuration in which the power supply unit 2 includes the remaining life storage unit 21 as illustrated in FIG. 1, even when the control unit 3 is replaced, a new control unit 3 after the replacement can still use the remaining life information stored in the remaining life storage unit 21 to obtain the remaining life of the power supply unit 2. Because a PLC is configured by combining units necessary for realizing functions required at a production site, the combination of units may be changed in accordance with changes in production equipment or the like. That is, the combination of a control unit and a power supply unit may be changed. For example, if the number of units constituting a PLC increases, the need to replace a power supply unit with a larger capacity power supply unit may arise, At this time, the power supply unit is not always replaced by a new power supply unit, and it may be replaced by a power supply unit that has been used in another PLC. There is also a case where a control unit may fail and thus the need to replace the control unit may arise. When a control unit stores remaining life information on a power supply unit, if the combination of the control unit and the power supply unit is changed, it is impossible to calculate the remaining life of the power supply unit after the change. In contrast, when the power supply unit includes a remaining life storage unit, it is possible to calculate the remaining life of the power supply unit even after the combination of the control unit and the power supply unit is changed.

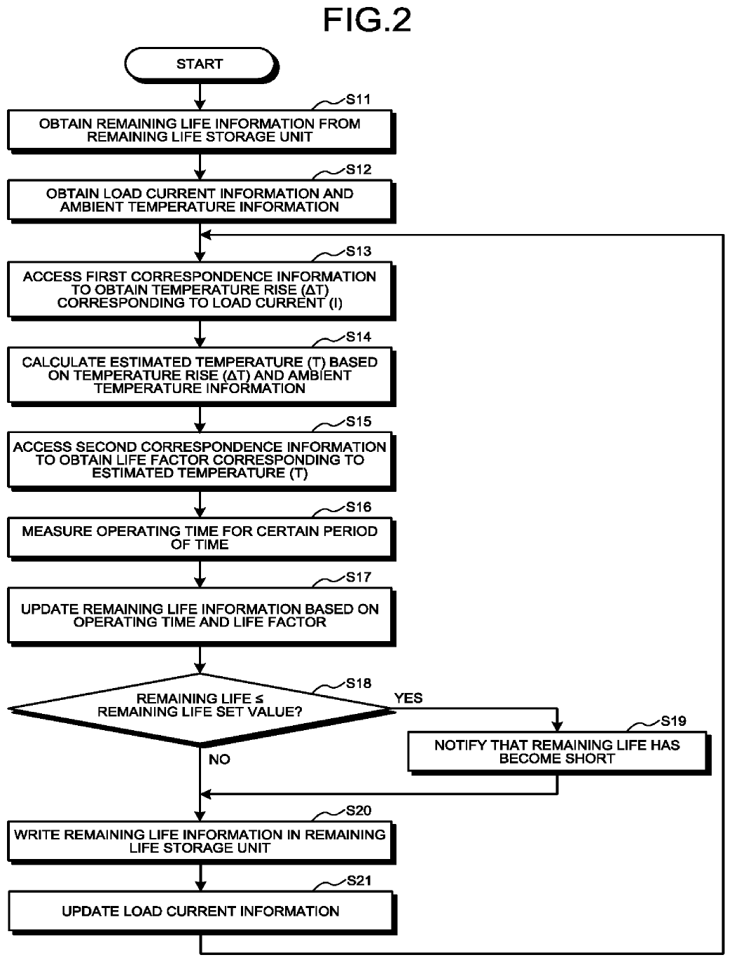

Next, a description will be given of an operation of the PLC 100, i.e., an operation of the PLC 100 when the control unit 3 calculates the remaining life of the power supply unit 2 equipped with the limited-life component. FIG. 2 is a flowchart illustrating an example operation of the PLC 100. The operation according to the flowchart illustrated in FIG. 2 is performed by the control unit 3.

The control unit 3 starts the operation illustrated in FIG. 2 when the power to the PLC 100 is turned on.

When the power to the PLC 100 is turned on, first, the remaining life calculation unit 33 in the life assessment unit 30 of the control unit 3 obtains the remaining life information from the remaining life storage unit 21 of the power supply unit 2 (step S11). Furthermore, the estimated temperature calculation unit 32 in the life assessment unit 30 of the control unit 3 obtains the load current information and the ambient temperature information from the storage unit 36 (step S12).

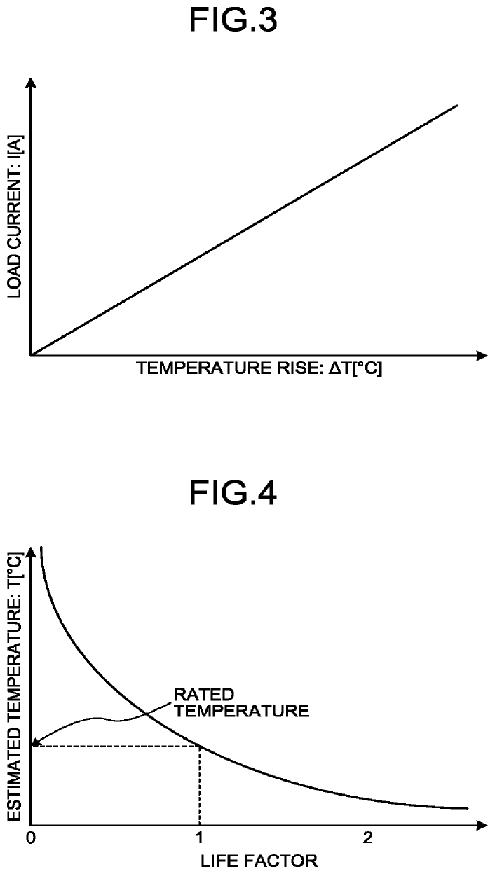

Next, the estimated temperature calculation unit 32 accesses the first correspondence information stored in the storage unit 36 and obtains the temperature rise (ΔT) corresponding to the load current (I) (step S13). FIG. 3 is a diagram illustrating an example of the first correspondence information. As illustrated in FIG. 3, the first correspondence information is information indicating the correspondence between the load current and the temperature rise. The first correspondence information may be any information that shows the correspondence relationship between the load current and the temperature rise, and it may be a mathematical formula. In step 313, the estimated temperature calculation unit 32 uses the first correspondence information to calculate the temperature rise (ΔT) corresponding to the load current (I) indicated by the load current information obtained in step S12.

Next, the estimated temperature calculation unit 32 calculates an estimated temperature (T) on the basis of the temperature rise (ΔT) obtained in step 313 and the ambient temperature information obtained in step 312 (step S14). In step 314, the estimated temperature calculation unit 32 calculates the estimated temperature by adding the temperature rise to the ambient temperature indicated by the ambient temperature information. The estimated temperature is an estimated value of the temperature of the limited-life component of the PLC 100 in a state where the PLC 100 is in operation.

Next, the remaining life calculation unit 33 accesses the second correspondence information stored in the storage unit 36 and obtains the life factor corresponding to the estimated temperature (T) (step 15). FIG. 4 is a diagram illustrating an example of the second correspondence information. As illustrated in FIG. 4, the second correspondence information is information indicating the correspondence between the estimated temperature and the life factor. The higher the estimated temperature, the lower the life factor. When the estimated temperature is equal to the upper temperature limit of the limited-life component and satisfies the life specification of the power supply unit 2, the life factor of the power supply unit 2 is 1. The upper temperature limit of the limited-life component is the upper temperature limit in a temperature range within which the operation of the limited-life component is guaranteed. For example, when the temperature range within which the operation is guaranteed is 0 to 30° C., the upper temperature limit of the limited-life component is 30° C. The upper temperature limit of the limited-life component corresponds to the “rated temperature” illustrated in FIG. 4. It should be noted that the second correspondence information may be any information that shows the correspondence relationship between the estimated temperature and the life factor, and it may be a mathematical formula. In step S15, the remaining life calculation unit 33 uses the second correspondence information to obtain the life factor corresponding to the estimated temperature (T) calculated in step S14.

Next, the operating time measurement unit 34 in the life assessment unit 30 of the control unit 3 measures the operating time of the PLC 100 for a certain period of time (step S16). The operating time measurement unit 34 measures the operating time of the PLC 100 for a predetermined certain period of time such as thirty minutes or one hour. The operating time measurement unit 34 monitors whether an operation to start the PLC 100 has been performed while the PLC 100 is not in operation and monitors whether an operation to stop the PLC 100 has been performed while the PLC 100 is in operation to measure the operating time of the PLC 100. That is, upon detecting an operation to start the PLC 100, the operating time measurement unit 34 starts timing, and upon detecting an operation to stop the PLC 100, the operating time measurement unit 34 stops timing.

Next, the remaining life calculation unit 33 in the life assessment unit 30 of the control unit 3 updates, on the basis of the operating time measured by the operating time measurement unit 34 in step S16 and the life factor obtained in step 215, the remaining life information obtained and stored in step S11 (step The remaining life calculation unit 33 calculates the remaining life after the update according to the following formula (2), and it updates the remaining life information to a value representing the remaining life after the update.

(Remaining life after update)=(remaining life before update)−(operating time)/(life factor) (2)

Next, the remaining life calculation unit 33 determines whether the remaining life indicated by the updated remaining life information is equal to or less than a predetermined remaining life set value that is a threshold value (step S18). When the remaining life is not equal to or less than the remaining life set value (step S18: No), the remaining life calculation unit 33 writes the updated remaining life information in the remaining life storage unit 21 of the power supply unit 2 (step S20). In contrast, when the remaining life is equal to or less than the remaining life set value (step S18: Yes), the life notification unit 35 of the control unit 3 notifies the user that the remaining life of the power supply unit 2 has become short (step S19). The remaining life set value is set to a value such that a notification to the user is made when the remaining life of the power supply unit 2 is thirty hours, for example. The remaining life set value may be changed by the user. The life notification unit 35 may make a notification to the user in any way. The life notification unit 35 may use a display device such as a display to make a notification to the user, or it may use a light emitting diode (LED) to make a notification to the user. Other methods may also be used to make a notification to the user. After the life notification unit 35 executes step S19, the remaining life calculation unit 33 executes step S20.

Although not described in FIG. 2, the control unit 3 constantly monitors whether an operation to turn off the power to the PLC 100 has been performed. When the control unit 3 detects that an operation to turn off the power has been performed, the control unit 3 stops controlling each controlled unit 4 and writes the latest remaining life information at that point of time in the remaining life storage unit 21 of the power supply unit 2. That is, when the control unit 3 detects that an operation to turn off the power has been performed, the control unit 3 executes the same processing as the processing in step S20 illustrated in FIG. 2. As described above, the remaining life information stored in the remaining life storage unit 21 of the power supply unit 2 is updated also when an operation to turn off the power to the PLC 100 has been performed. Thus, it is possible to omit the processing in step S20 illustrated in FIG. 2. However, there is a possibility that the operation of the PLC 100 may be stopped without an operation to turn off the power due to a power failure or the like. By including the processing in step S20, the accuracy of estimating when to replace the unit equipped with the limited-life component can be improved.

After the execution of step S20, then, the load current calculation unit 31 in the life assessment unit 30 of the control unit 3 updates the load current information (step S21). In step S21, the load current calculation unit 31 determines whether there is a change in the load current flowing in the PLC 100, and if there is a change, it updates the load current information. When the load current calculation unit 31 updates the load current information, the load current calculation unit 31 transfers the updated load current information to the estimated temperature calculation unit 32. After the execution of step S21, the process returns to step S13.

Here, the reason for executing step S21 will be given. The configuration of the PLC 100 may be changed during operation. Specifically, the controlled unit 4 attached to the base unit 1 may be removed, a new controlled unit 4 may be attached to the base unit 1, or the controlled unit 4 attached to the base unit 1 may stop operating due to a failure or the like. When the configuration of the PLC 100 changes, the load current also changes. Thus, the load current calculation unit 31 determines whether the configuration of the PLC 100 has changed, and it updates the load current information when the load current calculation unit 31 has detected a change in the configuration. By updating the load current information in accordance with changes in the configuration of the PLC 100, the accuracy of calculating the remaining life can be improved and thus the user can be notified of an appropriate time to replace the power supply unit 2.

The determination as to whether the configuration of the PLC 100 has changed is performed by the load current calculation unit 31 transmitting a control signal to determine the presence or absence of each of the controlled units 4. Specifically, the load current calculation unit 31 transmits a control signal for determining the presence or absence of the controlled units 4, and each controlled unit 4 that has received the control signal transmits a response signal. The response signal includes identification information that identifies the controlled unit 4 as a transmission source. The load current calculation unit 31 determines that the controlled unit 4, as a transmission source of the received response signal, is attached to the base unit 1 and is operating.

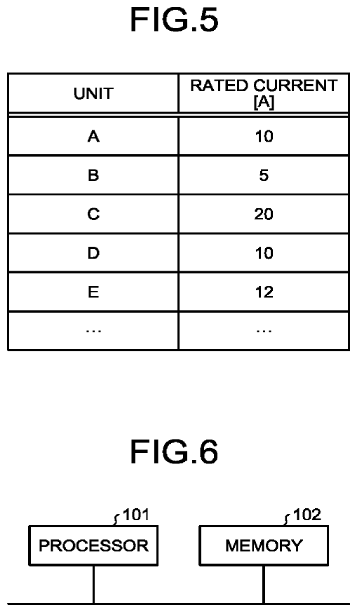

Upon completing the determination as to whether the configuration of the PLC 100 has changed, i.e., determining whether there is the operating controlled unit 4, the load current calculation unit 31 calculates updated load current information on the basis of the determination results. Specifically, the load current calculation unit 31 calculates, as the load current information, the total value of the rated current of the operating controlled unit 4, the rated current of the power supply unit 2, and the rated current of the control unit 3. The rated currents of the operating controlled unit 4, the power supply unit 2, and the control unit 3 can be obtained from the rated current information stored in the storage unit 36. FIG. 5 is a diagram illustrating an example of the rated current information stored in the storage unit 36. The rated current information includes identification information such as the names of the units and rated current values. It is assumed that the rated current information includes identification information and rated current values of all units that can be attached to the base unit 1 of the PLC 100, i.e., the power supply unit 2, the control unit 3, and the controlled unit 4. For example, when the P 100 is composed of units corresponding to A to D illustrated in FIG. 5, the load current calculation unit 31 set 10+5+20+10=45[A] as the updated load current information.

When configuration of the PLC 100 has not changed, the load current calculation unit 31 may not necessarily calculate the updated load current information. The load current calculation unit 31 may write the updated load current information in the storage unit 36. Transmission of a control signal for determining whether the configuration of the PLC 100 has changed, i.e., transmission of a control signal for determining the presence or absence of each of the controlled units 4, may be performed by any unit other than the load current calculation unit 31. The control unit 3 may perform the processing of transmitting a control signal for determining whether the configuration of the PLC 100 has changed and receiving a response signal at a given timing while the processing in steps S13 to S20 is being performed instead of after the execution of step S20. For example, the control unit 3 may transmit a control signal for determining the presence or absence of each of the controlled units 4 at a fixed cycle.

Next, a description will be given of hardware for realizing the components of the control unit 3 illustrated in FIG. 1. FIG. 6 is a diagram illustrating an example configuration of hardware that realizes the control unit 3. The load current calculation unit 31, the estimated temperature calculation unit 32, the remaining life calculation unit 33, the operating time measurement unit 34, and the life notification unit 35 of the control unit 3 can be realized by a processor 101 and a memory 102 illustrated in FIG. 6. Specifically, programs for operating as the load current calculation unit 31, the estimated temperature calculation unit 32, the remaining life calculation unit 33, the operating time measurement unit 34, and the life notification unit 35 are stored in the memory 102, and the processor 101 reads and executes the programs stored in the memory 102, thereby implementing these components.

The processor 101 is a processing circuit such as a central processing unit (CPU, also referred to as a central processing device, a processing device, an arithmetic device, a microprocessor, a microcomputer, a processor, and a digital signal processor (DSP)), or a system large-scale integration (LSI). The memory 102 s a nonvolatile or volatile semiconductor memory, such as a random access memory (RAM), a read only memory (ROM), a flash memory, an erasable programmable read only memory (EPROM), or an electrically erasable programmable read-only memory (EEPROM), a magnetic disk, an optical disk, or the like.

As described above, in the PLC 100 according to the present embodiment, the control unit 3 calculates, on the basis of the load current information and the ambient temperature information, the estimated temperature of the limited-life component in the PLC 100 in the state in which the PLC 100 is operating; and calculates the remaining life of the power supply unit 2 on the basis of the life factor corresponding to the estimated temperature of the limited-life component and the operating time of the PLC 100. Consequently, it is possible to calculate when to replace the power supply unit 2 while at the same time preventing the cost of the PLC 100 from increasing. Furthermore, because the power supply unit 2 stores the remaining life information about itself, even when the control unit 3 used in combination with the power supply unit 2 is changed, it is still possible to calculate when to replace the power supply unit 2 in the PLC 100 after the combination has been changed.

In the present embodiment, for the sake of simplicity of explanation, the description has been provided on the assumption that only the power supply unit 2 is equipped with a limited-life component. However, some or all of the controlled units 4 may be equipped with a limited-life component. That is, the PLC 100 may include a plurality of limited-life-component-equipped units. In that case, the controlled unit 4 corresponding to a limited-life-component-equipped unit includes a remaining life storage unit for storing remaining life information in a similar manner to the power supply unit 2. When there are a plurality of limited-life-component-equipped units, the storage unit 36 of the control unit 3 stores the first correspondence information and the second correspondence information described above for each of the limited-life-component-equipped units. The life assessment unit 30 uses the first correspondence information and the second correspondence information associated with the limited-life-component-equipped units when calculating the remaining life of the limited-life-component-equipped units.

Although a case where the control unit 3 includes the life notification unit 35 has been described, the power supply unit 2 or the controlled unit 4 may include a life notification unit.

The description has been provided on the assumption that the storage unit 36 stores the load current information in advance, and the estimated temperature of the limited-life component in the PLC 100 is calculated using the load current information. Alternatively, means for measuring the load current may be included, the estimated temperature of the limited-life component in the PLC 100 may be calculated using the actually measured load current value, and the remaining life of the power supply unit 2 may be calculated on the basis of the calculated estimated temperature.

In the present embodiment, the description has been provided on the assumption that temperature control is performed such that the temperature is constant at the production site where the PLC 100 is installed. However, there is a possibility that the PLC 100 is installed in an environment where temperature control is not performed. In such a case, the control unit 3 of the PLC 100 stores, instead of the above-described ambient temperature information, information for estimating the ambient temperature in the storage unit 36. The information for estimating the ambient temperature is, for example, a graph showing daily temperature variations (variations in ambient temperature). When the control unit 3 calculates the remaining life of the power supply unit 2 using the graph showing the daily temperature variations, first, after the power to the PLC 100 is turned on, the control unit 3 checks the current time against the graph showing the temperature variations in order to obtain an estimated value of the ambient temperature. Next, the control unit 3 uses the obtained estimated value in place of the ambient temperature indicated by the above-described ambient temperature information to calculate the estimated temperature of the limited-life component. That is, in step S12 illustrated in FIG. 2, the control unit 3 obtains the load current information and the information that is used for estimating the ambient temperature and that is the graph showing the daily temperature variations, and then it obtains the estimated value of the ambient temperature on the basis of the graph showing the daily temperature variations and the time information. Then, in step S14 illustrated in FIG. 2, the control unit 3 calculates the estimated temperature T on the basis of the temperature rise ΔT and the estimated value of the ambient temperature. Because the ambient temperature varies over time, the control unit 3 repeatedly executes the processing to obtain the estimate value of the ambient temperature on the basis of the graph bowing the daily temperature variations and the time information at fixed intervals, for example, every ten minutes, in order to update the estimated value of the ambient temperature.

The above-described graph showing the daily temperature variations may be a correspondence table between time and ambient temperature. Because the temperature varies according to the season, the control unit 3 may store twelve types of “graphs showing daily temperature variations” or “correspondence tables between time and ambient temperature” corresponding respectively to the months from January to December in the storage unit 36, and the twelve types of graphs or correspondence tables then may be selectively used. Alternatively, the control unit 3 may store one type of “graph showing daily temperature variations” or “correspondence table between time and ambient temperature” in the storage unit 36, and after correcting this on the basis of the date and time, the control unit 3 may obtain an estimated value of the ambient temperature. Furthermore, the control unit 3 may correct e estimated value of the ambient temperature on the basis of weather information. For example, when the weather is “sunny,” the control unit 3 corrects the estimated value of the ambient temperature obtained from the current time and the graph or the like to a larger value, and when the weather is “rainy,” the control unit 3 corrects the estimated value of the ambient temperature to a lower value. In this case, the control unit 3 obtains weather information from an external device via a communication network that is not illustrated in FIG. 1. In addition to the weather information, the control unit 3 may obtain information on an hourly temperature forecast, for example.

The configuration illustrated in the above embodiment illustrates an example of the subject matter of the present invention, and it can be combined with another known technology or can be partly omitted or changed without departing from the scope of the present invention.

### REFERENCE SIGNS LIST

1 base unit; power supply unit; 3 control unit; 4 controlled unit; 21 remaining life storage unit; 30 life assessment unit; 31 load current calculation unit; 32 estimated temperature calculation unit; 33 remaining life calculation unit; 34 operating time measurement unit; 35 life notification unit; 36 storage unit; 100 programmable logic controller (PLC).

1. A programmable logic controller configured to include a controller and a limited-life-component-equipped unit equipped with a limited-life component, wherein
the limited-life-component-equipped unit comprises
a remaining life storage to store remaining life information indicating a remaining life of the limited-life-component-equipped unit, and
the controller comprises
a load current calculator to calculate a load current flowing in the programmable logic controller,
an estimated temperature calculator to calculate, on a basis of ambient temperature information obtained from a user and the load current, an estimated value of temperature of the limited-life component when the programmable logic controller is in operation, and
a remaining life calculator to update the remaining life information on a basis of operating time of the programmable logic controller and the estimated value.

2. The programmable logic controller according to claim 1, comprising a life notifier to notify, when the remaining life of the limited-life-component-equipped unit becomes equal to or less than a threshold value, the user of information indicating that the remaining life of the limited-life-component-equipped unit becomes equal to or less than the threshold value.

3. The programmable logic controller according to claim 1, wherein the limited-life-component-equipped unit is a power supply.

4. The programmable logic controller according to claim 1, wherein the load current calculator calculates, as the load current, a total value of rated current values of units constituting the programmable logic controller.

5. The programmable logic controller according to claim 1, wherein the remaining life calculator subtracts time obtained by multiplying the operating time by a life factor derived from the estimated value from the remaining life and sets information indicating a subtraction result as the remaining life information after being updated.

6. The programmable logic controller according to claim 5, wherein
the limited-life-component-equipped unit is a plurality of limited-life-component-equipped units, and
the remaining life calculator obtains the life factor for each of the limited-life-component-equipped units and calculates, using the life factor corresponding to each of the limited-life-component-equipped units, remaining life information for each of the limited-life-component-equipped units.

7. (canceled)

8. A method of calculating a remaining life of a limited-life-component-equipped unit equipped with a limited-life component in a programmable logic controller configured to include a controller and the limited-life-component-equipped unit, the limited-life-component-equipped unit storing remaining life information indicating the remaining life of the limited-life-component-equipped unit, the method comprising:
calculating a load current flowing in the programmable logic controller;
calculating, on a basis of ambient temperature information obtained from a user and the load current, an estimated value of temperature of the limited-life component when the programmable logic controller is in operation; and
updating, on a basis of operating time of the programmable logic controller and the estimated value, the remaining life information.

9. A limited-life-component-equipped unit equipped with a limited-life component and constituting a programmable logic controller together with a controller that comprises a load current calculator to calculate a load current flowing in the programmable logic controller and a remaining life calculator to update remaining life information indicating a remaining life of the limited-life-component-equipped unit, on a basis of ambient temperature information, the load current, and operating time of the programmable logic controller, the limited-life-component-equipped unit comprising:
a remaining life storage to store the remaining life information.
